(19) United States
(12) Patent Application Publication
(10) Pub. No.: US 2026/0093303 A1
(43) Pub. Date: Apr. 2, 2026

(54) MULTIPLE WINDOW POWER ESTIMATION FOR A CLUSTER OF CORES

(71) Applicant: Google LLC, Mountain View, CA (US)

(72) Inventors: Sushanth R Nukala, Austin, TX (US); Kushal Chikkaraju, MILPITAS, CA (US); Laurent Francois Chaouat, JONESTOWN, TX (US)

(21) Appl. No.: 18/900,205

(22) Filed: Sep. 27, 2024

(51) Int. Cl. G06F 1/26

(52) U.S. Cl. CPC G06F 1/26

(57) ABSTRACT

Methods, systems, and apparatus, including microelectronic circuits and processors are described for estimating energy consumption during a sampling window. The processor is divided into multiple processor cores, which are each sub-divided into processor units. The units can perform operations from a set of operations. Based on the number of times each unit has performed a particular operation during a sampling window, an estimate of the energy consumed by that unit for that sampling window is calculated. By summing the estimated energy consumption of many units on a core and many cores of the entire system, an energy consumption estimate is prepared for the sampling window. Other power parameters may be calculated from a sampling window duration and the energy consumption estimate. If a power parameter exceeds a threshold, action may be taken to alter operation of the microelectronic circuit.

### BACKGROUND

Modern integrated circuits pack a high density of circuit elements into a very small area. Such a high density of circuits can lead to the danger of overheating which can interfere with proper operation of the circuits, reduce reliable operation of the circuits, and also reduce the circuits' operational lifetime.

As processors are reduced in size the problems associated with waste heat become more critical. To prevent multi-core chips from overheating, it is necessary to develop methods for quickly and efficiently estimating the power consumed by each core.

### SUMMARY

This specification relates to estimation of the power consumed on a multi-core chip.

In general, one innovative aspect of the subject matter described in this specification can be embodied in a processor that includes a plurality of processor cores. Each processor core includes a plurality of processor units, and each processor unit is configured to perform a particular processor core function. Each processor unit monitors for occurrences of events in a set of events for the processor unit, where each set of events specific to the processor unit. Each processor unit determines, for a plurality of sampling windows, where at least some of the sampling windows are different from each other sampling window, an energy consumption estimate for the sampling window based on the monitored occurrences of the events. Each processor core provides each energy consumption estimate for each sampling window for each processor unit to a controller of the processor. The controller of the processor determines, one or more activity adjustment control signals, each of the one or more activity adjustment control signals operable to cause an adjustment of activity of a processor core. The controller of the processor provides the one or more activity adjustment control signals to one or more corresponding processor cores to which they are addressed. Other embodiments of this aspect include corresponding systems, apparatus, and computer programs, configured to perform the actions of the methods, encoded on computer storage devices.

In some implementations, prior to each processor unit monitoring for the occurrences of the events, the controller sends a synchronizing pulse to each processor unit to initiate each sampling window of a plurality of sampling windows. A power consumption estimate for each processor unit for each sampling window is determined by dividing each energy consumption estimate by a duration of each sampling window.

In some implementations, for each processor unit, each of the events that are monitored is associated with a respective weight determined for the event. Each processor unit determines energy consumption estimates for the plurality of sampling windows. The determination includes, for each sampling window and for each of event of the set of events for each processor unit, counting a number of occurrences of the event during the sampling window and multiplying the number of occurrences of the event during the sampling window by the respective weight associated with the event to determine a product for the event. The processor unit sums, for all the events, the product of the events to determine the energy consumption estimate during the sampling window. Each respective weight is programmable by the controller. The processor can include one or more multiplexers. Each multiplexer is associated with a processor core. Each energy consumption estimate for each of the plurality of sampling windows is transmitted to the controller by the associated multiplexer. Each multiplexer can also transmit a sampling window duration associated with the energy consumption estimate to the controller. The activity adjustment control signals comprise at least one of a clock frequency adjustment signal, a voltage adjustment signal, a throttling adjustment signal, or a current adjustment signal. The activity adjustment control signals are generated in response to a power parameter comprising at least one of a current, a power, a differential power, a differential current, and an energy. Durations for each of the plurality of sampling windows are programmable by the controller.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an integrated circuit with a processor and the energy estimating circuit portions.

FIG. 2 is a flow chart of an example process of estimating energy consumption.

Like reference numbers and designations in the various drawings indicate like elements.

### DETAILED DESCRIPTION

This specification describes techniques for estimating the power and energy consumed by a multi-core processor and by different units or portions or sub-sections of the entire die.

Modern integrated circuits pack a high density of circuit elements into a very small area. Such a high density of circuits can lead to the danger of overheating which can interfere with proper operation of the circuits, reduce reliable operation of the circuits, and also reduce the circuits' operational lifetime. It is therefore advantageous to monitor the energy and power being consumed by different portions of an integrated circuit in order to be able to reduce energy or power consumption of the IC when necessary. By estimating the energy consumed during different sampling windows (also referred to as time windows), different alarms, alerts, or reactions can occur at a controller to prevent or mitigate potential problems of operating the IC. The different sampling windows enable the accumulation of energy consumption and power consumption over different time frames, which facilitates determining different characteristics of the IC in operation. For example, long duration sampling windows allow time for heat to flow from hotter regions to cooler regions and equilibrate across the entire IC die. Conversely, short duration sampling windows help detect over-taxing the power supply during short durations that are too short to affect heating the entire die.

Multiple methods exist for preventing over-heating, current spikes, poor power management, and poor energy management for ICs running off the same power supply. In short, for appropriate power management to enhance IC operation or prolong IC life and reliability, it is advantageous to quickly estimate how much energy has been consumed at any given time on different parts of the integrated circuit. Such estimations are determined quickly and with little overhead to obtain estimated energy and/or power consumptions values for different portions of the integrated circuit over multiple different time windows.

For each processor unit of each core processor on the IC, events corresponding to particular operations are counted. By counting the number of each of the types of events and multiplying this number by an associated weight, the energy consumed by the processor unit may be quickly estimated. The overhead for this feature is minimal since it requires only a counter circuit and identification of the type of event, which can, for example, be stored in a look-up table. The weights may be determined separately and updated as needed. Based on the estimate of the energy consumed, a controller circuit can modify or adjust the operation of the chip as needed. In addition, a synchronizing pulse is sent out by the controller to synchronize all the data collection across all cores.

These features and additional features are described in more detail in the sections that follow.

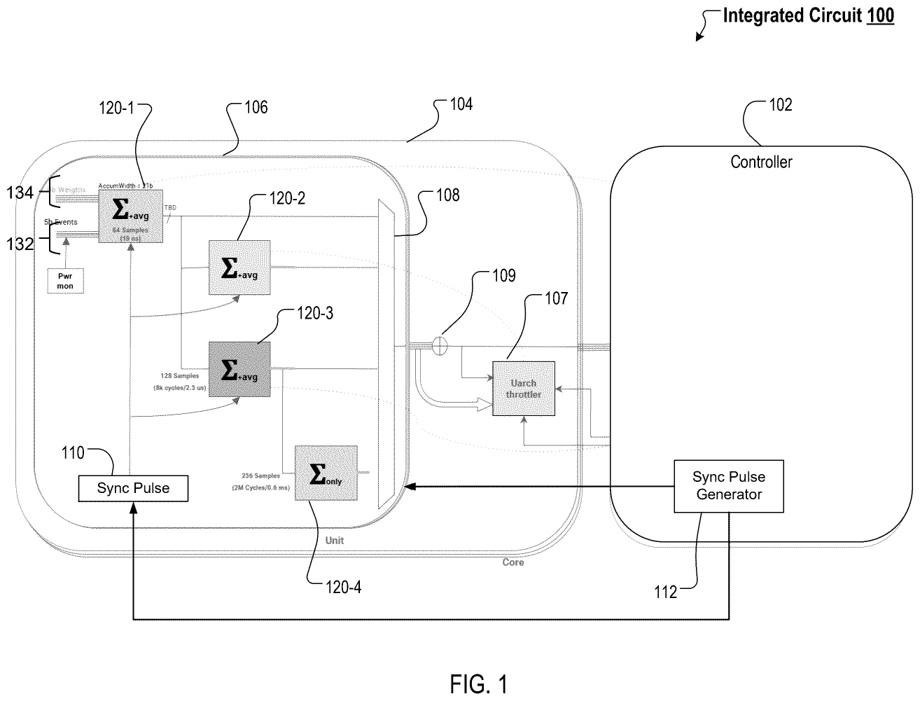

FIG. 1 is an illustration an example of an integrated circuit 100 with a controller 102 and a processor core 104 with a processor unit 106. For each processor unit 106, energy estimating circuits 120 monitor for occurrences of events in a set of events for the processor unit 106. Each set of events so monitored is specific to the processor unit 106. Additionally, the energy estimating circuits 120 determine, for a plurality of sampling windows, an energy consumption estimate for the sampling window based on the monitored occurrences of the events. Each sampling window is different from each other sampling window.

The integrated circuit 100 includes at least one processor and may include multiple processors which may include multiple processor cores 104. Each processor core 104 includes a processor unit 106. The processor core 104 is not limited to a single processor unit 106 but can include multiple processor units 106. Each processor unit 106 is configured to perform a particular processor core function for the processor core 104. The functions may differ for each processor unit 106. Any number of processor units 106 may be employed. Similarly, the number of cores 104 is not limited to one core 104 and the chip 100 may include multiple cores 104.

The controller 102 may include a synchronizing pulse generator 112 that provides a synchronizing pulse 110 to each unit 106 of the processor core 104. In addition, each of the energy estimating circuits 120 provides a signal to the controller via a multiplexer 108 for that unit 106. Each core 104 has at least one multiplexer 108 and may have more than one multiplexer. In some implementations, the multiplexer 108 outputs one estimation value at a time to the controller 102, from among the input estimation values the energy estimating circuits 120 provide. In some implementations, the processor core 104 provides the estimated energy consumption to the controller 102 for a particular sampling window. The multiplexer 108 outputs the energy consumption estimate and the associated sampling window to the controller 102. The duration for each sampling window is programmable by the controller 102 or, alternatively, coded into each energy estimating circuit 120.

In some implementations, the estimation values may be accumulated in an accumulator 109 for the unit 106 and for each unit of the processor core 104 on a per-window basis and sent periodically to the controller 102. More specifically, the accumulator 109 receives the estimates and processes the estimates depending on the particular implementation used. For example, the accumulator 109 may accumulate the energy consumption estimate for all the processor units 106 for the processor core 104 for each particular sampling window duration and provide the accumulated value to the controller 102. In another implementation, the accumulator 109 may store the energy consumption estimates for all the processor units 106 for the processor core 104 for all particular sampling window durations and provide the values to the controller 102. Other appropriate processing of estimation values may also be used.

The estimation values output from the energy estimating circuits 120 to the controller 102 may include an estimate of energy consumed for the sampling window and an indication of the duration of the sampling window. A microarchitecture throttler 107 may also be included on each core 104 for throttling to reduce power consumption. The microarchitecture throttler 107 may react and send instructions to the processor core 104 depending on the results reported by the energy estimating circuits 120. In an example, the microarchitecture throttler 107 may have a power parameter threshold. If the estimated energy consumption exceeds the power parameter threshold, the microarchitecture throttler 107 may reduce the power consumed by the processor core 104.

In other implementations, controller 102 may send instructions for throttling and the microarchitecture throttler 107 may be omitted. While such implementations may result in a slightly delayed response relative to the implementation of the microarchitecture throttler 107, the overall architecture is simplified.

For each processing unit 106, the energy estimating circuits 120 monitor for occurrences of events in a set of events for the processor unit 106. Each set of events so monitored is specific to the processor unit. For example, the events may differ for different processing units 106 when each of the different processing units perform different processor core functions from each other.

The energy estimating circuits 120 determine, for multiple sampling windows, an energy consumption estimate for the sampling window based on the monitored occurrences of the events. At least some of the sampling windows are different from each other sampling window.

In this example, the unit 106 includes four energy estimating circuits: a first energy estimating circuit 120-1, a second energy estimating circuit 120-2, a third energy estimating circuit 120-3, and a fourth energy estimating circuit 120-4. Any number of energy estimating circuits may be used and four energy estimating circuits are used only as an example number of circuits. The first energy estimating circuit 120-1 has several sets of inputs depicted: the synchronizing pulse 110, a set of events 132, and a set of weights 134. In addition, there may be other inputs to the unit 106 such as, for example, a clock signal, a power signal, and process signals for performing calculations.

The set of events 132 is a set of events of operations which the unit 106 may perform. For example, the set of events to be detected may include simple integer arithmetic operations, floating point operations, Boolean logic, memory read/write operations, and the like. For each type of event there is an associated weight 134. The set of weights 134 may be provided by the controller 102 or the set of weights 134 may be stored on the processor core 104 or on the unit 106 or in other memory or storage. The set of weights 134 may be updated at any time. The set of weights 134 may be programmable by the controller 102. The set of weights 134 may be the same for all units 106 on a core 104 or the set of weights 134 may be different for each unit 106 and for each core 104. In the example shown there are five types of events 132 and five associated weights 134. The events are not limited to five types but may be any number of types. The weight is a measure of how much energy it is estimated that that type of event will consume when the unit performs the operation of the event.

The weights may be determined empirically. For example, energy consumption values may be monitored during testing, and the events may also be monitored and detected. Corresponding weights to determine the energy estimates may then be determined, e.g., by regression analysis, or any other appropriate process to determine weights based on detected events and energy consumption values.

The first energy estimating circuit 120-1 counts the number of each type of event during a first sampling window (e.g., a time window or a number of clock cycles). The counting starts when the synchronizing pulse 110 is received by the first energy estimating circuit 120-1 from the controller 102. After the first sampling window has elapsed, the first energy estimating circuit 120-1 multiplies the number of occurrences of each of the events by the associated weight of that event and sums the resulting set of products. Thus, in effect, by counting a number of events and multiplying this number by the mean energy used for performing the operation of the event, the energy consumed for all of those events which occurred during the first sampling window can be quickly estimated. One example formula for energy consumption is as follows:

$$Energy consumption estimate = {\sum }_{k = 1}^{m} {N}_{k} * {W}_{k} \qquad ( Equation 1 )$$

where Nₖ is the number of occurrences of the k^{th} event during the first sampling window and Wₖ is the weight assigned to the k^{th} event, and m is the number of the different types of events.

In the example depicted in FIG. 1, there are three additional energy estimating circuits 120-2, 120-3, and 120-4. The second energy estimating circuit 120-2 and the third energy estimating circuit 120-3 receive as inputs the output of the first energy estimating circuit 120-1 and also the synchronizing pulse 110. The fourth energy estimating circuit 120-4 receives as an input the output of the third energy estimating circuit 120-3 only.

The synchronizing pulse 110 may also be received by the energy estimating circuits. In the example depicted, the fourth energy estimating circuit 120-4 does not receive the synchronizing pulse but the first, second, and third energy estimating circuits 120-1, 120-2, and 120-3 do receive the synchronizing pulse 110 from the synchronizing pulse generator 112. In this example, the fourth energy estimating circuit 120-4 provides only an energy estimate and not a power estimate so there is no requirement to receive the synchronizing pulse 110 nor a conversion of the sampling window to a time. In addition, the fourth energy estimating circuit 120-4 can be reset or synchronized based on an alternative signal.

The second energy estimating circuit 120-2 may also have additional connections for additional signals, similar to the first energy estimating circuit 120-1. The second energy estimating circuit 120-2 integrates the estimated energy consumed by the unit 106, but over a second sampling window longer than the first sampling window. In an example, the first sampling window is 64 clock cycles of the processor core 104, which translates into 64 clock cycles of the unit 106. During this first sampling window, the unit 106 detects, for example, 5 events of the first event type and no events of other types. Thus, the estimated energy consumed is 5 times the weight for the first event type. In an example, if the energy per event is 1.5 nJ/event, then the energy consumed during the first sampling window is 5*1.5=7.5 nJ. Dividing this value by the time of the first sampling window (e.g., by the 64 clock cycles, and for an example, say that each clock cycle is 0.3 nsec (e.g., 3.3 GHZ clock frequency)) yields the power consumption (the rate of energy consumption)=7.5 nJ/19 ns≈0.389 W. In another example, during the next 64 clock cycles, the first type of event was performed only once and the second type of event was performed twice. If the second weight is 10 nJ/event, then the estimated energy consumed during the second set of 64 clock cycles=1*1.5+2*10=21.5 nJ which corresponds to a power of approximately 1.15 W.

The second energy estimating circuit 120-2 may be assigned a second sampling window that is longer than the first sampling window. In an example, if the second sampling window is 128 samples output by the first energy estimating circuit 120-1, then the second energy estimating circuit 120-2 may have a sampling window equal to 64*128 (=8192) clock cycles or approximately 2.5 us in time if the clock cycle is 0.3 ns. In some implementations the controller 102 may also perform the function of integrating over multiple sampling windows if a unit 106 has only a single energy estimating circuit 120. In other implementations, the unit 106 has multiple energy estimating circuits estimating energy consumption over multiple sampling windows. The second energy estimating circuit 120-2 may then output this estimated energy consumption value to the multiplexer 108 along with the second sampling window for transmission to the controller 102.

The third energy estimating circuit 120-3 may operation in a manner similar to the second energy estimating circuit 120-2, but on a different set of events and corresponding weights. In another example, the fourth energy estimating circuit 120-4 may have a sampling window which is 256 of the sampling windows of the third energy estimating circuit 120-3. The sampling window of the fourth energy estimating circuit 120-4 is therefore 256*128*64≈2M clock cycles or approximately 0.63 ms in time for the 0.3 ns clock cycle.

Although FIG. 1 illustrates four energy estimating circuits 120, any number of energy estimating circuits may be used. In an example, there may be five energy estimating circuits, each with an associated sampling window. The sampling windows may range from very short sampling windows of a few clock cycles to long sampling windows, such as several minutes or billions of clock cycles. The longer sampling windows may be useful for estimating heat dissipation and thermal effects since they allow enough time for a heated circuit element to spread the heat to other parts of the integrated circuit. The shorter sampling windows are useful so that the power supply does not have a large, sudden current draw or a large, sudden power draw which might cause other parts of the integrated circuit to lack power and operate inefficiently or unreliably.

The outputs of the energy estimating circuits may be compared to parameter thresholds. Different parameters thresholds may be set for different metrics. For example, a rate of change of current (di/dt) threshold may be set by the controller 102. If this di/dt threshold is exceeded, then the controller 102 may, for example, reduce the frequency of the clock signal to reduce the strain on the power supply. In another example, if a processor operates off of a battery and has certain critical functions so that the energy remaining in the battery is not permitted to fall below a certain limit, then this limit may be stored by the controller and act as a threshold for notification that the device must be turned off in the near future.

For the example of multiple cores, the synchronization pulse 110 is sent at the same time by the controller to all of the cores so that the cores have their energy consumption estimated for the same time period. The synchronization pulse 110 synchronizes the start of measurement for the shortest sampling window across all the cores. In a worst case, there is a loss of the first few clock cycles while the cores start to execute commands, or while the newly starting cores wait a few clock cycles until the newly instructed core starts synchronized estimated energy consumption tracking with the already operating cores.

The controller 102 may control energy consumption in a variety of different ways. Several examples follow.

### Example 1. Limited Power Budget

In this example, the power supply for the integrated circuit is limited to a maximum power value. In such an example, the energy is estimated for each of the units on each of the cores and divided by the time of the sampling window to produce a nearly instantaneous power consumption. If the sum of all the power consumption of all the units on all the cores is, for example, within a certain value (e.g., within 90%) of the maximum power budget, then the controller may, for example, throttle activity by engaging in activity throttling. Activity throttling slows down or even temporarily halts the execution of some instructions.

In another example, the controller may reduce the clock frequency of all the cores. Clock gating reduces the clock frequency which also very quickly reduces the power consumption of the integrated circuit, at the cost of not performing the operations as quickly. In an alternative, the controller may reduce the clock frequency only of the core with the highest estimated power consumption over the previous sampling window.

### Example 2. Differential Current Limit

In this example, the controller is instructed to monitor the differential current (di/dt). When adding new operations, new units, or new cores, the immediate current draw from the power supply to the IC may be close to its limit. The controller may have a maximum di/dt that it can supply. If the di/dt reaches, for example, 75% of this maximum di/dt value, based on the largest di/dt over the last two sampling windows, the controller may perform activity throttling of the core, reduce the clock frequency of the core, or reduce the voltage of the core, or some combination of such activities.

### Example 3. Energy Budget

In this example, the power for the IC is supplied by a battery. The controller may store the maximum amount of energy which can be used on performing operations of the associated units on the associated cores. When the estimated energy consumed by the circuits controlled by the controller reaches a threshold, the controller may reduce clock frequency and provide an alert message to the user. The alert may be sent out at, for example, 10% of the maximum energy stored in the battery. The message may indicate that the user should save their work and that performance of the IC may be degraded until the battery is re-charged. At a second, lower threshold, for example at 2% of maximum energy remaining in the battery, the message may change to a more urgent one.

These examples illustrate how the controller evaluates the state of estimated energy consumption and determines how to react based on the state of estimated energy consumption. Other variables may also be taken into account in the controller's evaluation such as estimates of future workload, whether additional cores or additional units are being asked to perform additional tasks, battery state of charge, etc.

In another example, a subset of events 132 may be monitored in a particular core 104 or in a particular unit 106 of a particular core 104. The subset of monitored events may be used to determine a new set of weights 134 which more accurately reflect an active workload of a unit 106 or of a core 104. Monitoring particular events 132 may include transmitting to the controller 102 a flag signal when a number of occurrences of a particular event exceeds a threshold value within a particular sampling window.

The weights 134 assigned to different types of events 132 can be programmed by the controller, as needed. The sampling windows can also be updated or changed as needed by the controller. Updating the weights 134 makes it possible to accumulate differences in power parameters and also to reset the accumulation after the power consumption drops. For example, if a particularly computationally intensive action is scheduled to be performed at a particular time, and the computationally intensive operations are all of a single type and are known in advance to consume less energy per operation when all the units are performing this same operation at the same time, then the controller may schedule a change in weights 134 for that particular type of event 132 for the sampling window for which the intensive action is scheduled.

In addition, the weights 134 can be adapted to reflect changes in the workload behavior. A subset of events 132 can be monitored to determine the nature of the active workload. The weights 134 can be switched or changed to align with the ongoing workload. The weights 134 may be selected from a look-up tables based on characterization of various operations prior to the IC starting normal operation. The weights 134 may be scaled depending on the actual workload. These weight 134 changes may improve the accuracy of the energy consumption estimate.

It is also possible to interact with a selected software application to classify workloads and efficiently schedule the operations performed by assigning a particular unit or a particular core to run all of some type of operations associated with the selected application. For example, if an application is being executed involving many calculations of a particular type, (e.g., a decryption or encryption algorithm is being executed) then those operations governed by the application may be assigned to operate on a particular unit or a particular core which is known to be efficient, based on past energy consumption.

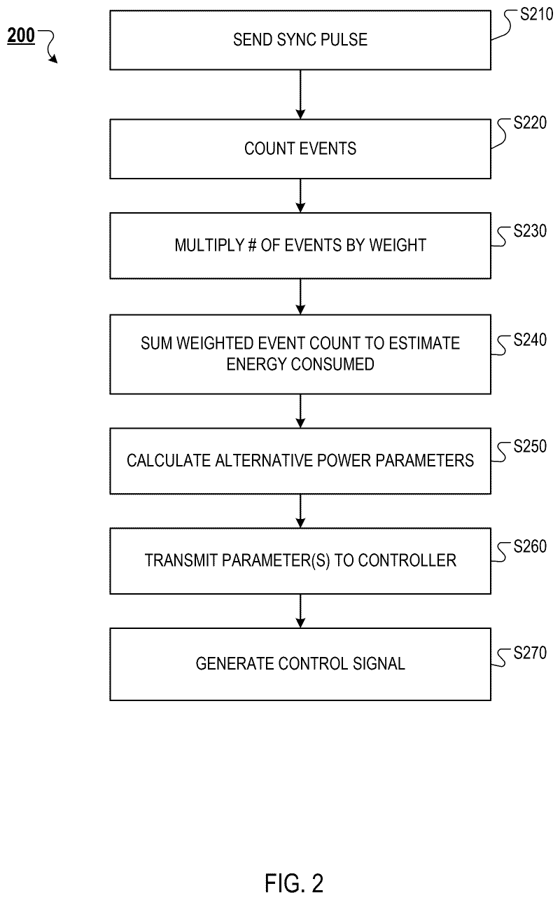

FIG. 2 illustrates a method of monitoring energy consumption by different units and cores and adjusting the power parameters of the cores accordingly.

At operation S210, the controller 102 instructs the synchronization pulse generator 112 to send out a synchronization pulse 110 to all the cores 104 whose energy consumption is being actively estimated. On each core 104, the synchronization pulse 110 is sent to at least one of the energy estimating circuits 120. This synchronization pulse 110 initiates the initial sampling window for estimating energy consumption. Once the energy estimating circuits 120 receive the synchronization pulse 110 the energy estimating circuits 120 start counting occurrences of the events 132. Synchronization allows a more accurate estimation of all the power parameters, especially of the differential parameters (e.g., di/dt or dPower/dt). If a first core starts at a first time and a second core starts at a second time different from the first time, then the estimated energy consumption will not accurately reflect the energy consumed by both during a first (e.g., a shortest) window. In such a non-synchronous situation, a second core would have a sampling window which only partially overlaps with the sampling window of the first core. The two energy estimating circuits would thus appear to report a lower power consumption than actually occurred because some of the events counted by the second core would not be reported as energy consumed during the first sampling window. Thus, initiating all the cores to start counting events at the same clock cycle assures the accuracy of the energy consumption estimate and also assures that rates of change of various parameters are not incorrectly underestimated.

At operation S220, the energy estimating circuit 120 counts events during the sampling window. The energy estimating circuit 120 counts the number of each of the different types of events. For example, if there are five types of events, the event counter will count the number of each type of event. In an example, event type 1 may have two occurrences, event type 2 may have zero occurrences, event type 3 may have 15 occurrences, event type 4 may have 12 occurrences, and event time 5 may have seven occurrences in the first sampling window as shown in Table 1 below.

At operation S230, the number of occurrences of the event during the sampling window (e.g., the event count) is multiplied by the weight associated with that type of event. In the example noted above, there are five types of events. Each event is assigned a weight, which approximates the energy consumption, on average, for that event. Multiplying the average energy per event by the number of occurrences of that event yields the weighted energy estimate.

At operation S240 the weighted energy estimates per event type are added together to produce the total estimated energy consumption for the unit for the selected sampling window. Table 1, below, shows the numbers from the example described in the preceding paragraphs. Although the energy units here are given in nanojoules (10⁻⁹ J), other units may also be used. For example, units of capacitance may be used at this stage and when the estimates are sent to the controller, the controller may convert the capacitances into energy values using a known switching voltage. In this example, the estimated energy consumption for the sampling window is 394 nJ.

TABLE 1
Sample energy estimation

| | # of | Weight | Weighted Energy |
|---|---|---|---|
| Event Type | Events | (nJ/event) | Estimate (nJ) |
| 1 | 2 | 58 | 116 |
| 2 | 0 | 150 | 0 |
| 3 | 15 | 8 | 120 |
| 4 | 12 | 1.5 | 18 |
| 5 | 7 | 20 | 140 |
| Total | | | 394 nJ |

At operation S250, alternative power parameters may be calculated. The calculations may be done in each respective estimating circuit 120 or in the controller 112. For example, the estimated energy consumption may be divided by the time duration of the sampling window to produce a power consumption. Other power-related parameters may also be calculated from the estimated energy consumption instead of, or in addition to, the estimated energy consumption. Examples of such power-related parameters include a current, a differential current (di/dt), a power, a differential power (dP/dt), an energy, and the like. In implementations for which the only parameter desired is the estimated energy consumption, then this operation is optional.

Another example power parameter is an efficiency for a processor core 104. The controller 102 may, for example, calculate the efficiency of each core 104 relative to other cores or to some benchmark. The controller 104 may transmit the efficiency to an external host. The external host may send instructions to the controller 104 assigning specific operations to be executed on specific cores based on the efficiency estimate for each core. In another example, the controller 102 itself may determine an efficiency for each core and may assign specific operations for each core based on the determined efficiency.

At operation S260, the estimated energy consumption and other power-related parameters, if any, are transmitted to the controller 102 along with the sampling window involved. In some implementations, the values transmitted are those calculated for other parameters in operation S250. The values from the different energy estimating circuits 120 of a single unit 106 may be transmitted to a multiplexer 108 to save on circuit real estate or wiring. The multiplexer 108 may sequentially transmit the outputs of the various energy estimating circuits 120 to the controller.

At operation S270 the controller generates an activity adjustment control signal (or signals) and transmits the activity adjustment control signal to the core or cores being affected. The control signal may instruct the core or various other elements to change how they are operating in order to control the power or a power-related parameter of the core or cores. In an example, the activity adjustment control signal may throttle activity for the core. In an example, the activity adjustment control signal may change the clock frequency of a core, or the activity adjustment control signal may change the switching voltage. In an example, the activity adjustment control signal may perform a combination of such activities: throttling, frequency reduction and voltage reduction. In an example, by reducing either the switching voltage or the clock frequency, the power consumption of the core may be reduced. In an example the activity adjustment control signal may change a current. The activity adjustment control signal may also indicate to the core(s) to increase the clock frequency because other cores have reduced their energy consumption. The activity adjustment control signal may also assign different cores or different units to cease operation or to begin operation or it may instruct them to operate differently. The activity adjustment control signal may be based on the estimated energy consumption or a power parameter calculated therefrom and also based on other information or other signals. Examples of such power parameters include an energy, a current, a differential current, a power, a differential power, and an efficiency.

Energy estimating circuits 120 can be realized by any appropriate digital circuitry. For examples, counters and registers may be used to implement estimating circuits. The estimating circuits 120 may also include multipliers, summers and the like if the circuits 120 also determine the energy consumption values.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A processor, comprising:
a plurality of processor cores, wherein:
each processor core comprises a plurality of processor units; and
each processor unit is configured to perform a particular processor core function;
for each processor unit:
monitoring for occurrences of events in a set of events for the processor unit, each set of events specific to the processor unit; and
determining, for a plurality of sampling windows, wherein at least some of the sampling windows are different from each other sampling window, an energy consumption estimate for the sampling window based on the monitored occurrences of the events;
for each processor core:
providing each energy consumption estimate for each sampling window for each processor unit to a controller of the processor;
determining, by the controller, one or more activity adjustment control signals, each of the one or more activity adjustment control signals operable to cause an adjustment of activity of a processor core; and
providing, by the controller, the one or more activity adjustment control signals to one or more corresponding processor cores to which they are addressed.

2. The processor of claim 1, wherein, prior to each processor unit monitoring for the occurrences of the events, the controller sends a synchronizing pulse to each processor unit to initiate each sampling window of a plurality of sampling windows.

3. The processor of claim 1, wherein a power consumption estimate for each processor unit for each sampling window is determined by dividing each energy consumption estimate by a duration of each sampling window.

4. The processor of claim 1, wherein:
for each processor unit, each of the events that are monitored is associated with a respective weight determined for the event;
for each processor unit, determining energy consumption estimates for the plurality of sampling windows comprises, for each sampling window:
for each event of the set of events for each processor unit:
counting a number of occurrences of the event during the sampling window;
multiplying the number of occurrences of the event during the sampling window by the respective weight associated with the event to determine a product for the event;
for all the events, summing the product of the events to determine the energy consumption estimate by the processor unit during the sampling window.

5. The processor of claim 4, wherein each respective weight is programmable by the controller.

6. The processor of claim 2, further comprising one or more multiplexers, each multiplexer associated with a processor core, wherein each energy consumption estimate for each of the plurality of sampling windows is transmitted to the controller by the associated multiplexer.

7. The processor of claim 6, wherein each multiplexer also transmits a sampling window duration associated with the energy consumption estimate to the controller.

8. The processor of claim 1, wherein the activity adjustment control signals comprise at least one of a clock frequency adjustment signal, a voltage adjustment signal, a throttling adjustment signal, or a current adjustment signal.

9. The processor of claim 1, wherein the activity adjustment control signals are generated in response to a power parameter comprising at least one of a current, a power, a differential power, a differential current, and an energy.

10. The processor of claim 1, wherein durations for each of the plurality of sampling windows are programmable by the controller.

11. A method for estimating energy consumption of one or more processor cores comprising:
monitoring, for each processor unit of a plurality of processor units of the one or more processor cores, for occurrences of events in a set of events for the processor unit, each set of events specific to the processor unit, wherein each processor unit is configured to perform a particular processor core function;
determining, for each processor unit, for a plurality of sampling windows, wherein at least some of the sampling windows are different from each other sampling window, an energy consumption estimate for the sampling window based on the monitored occurrences of the events;
providing, for each of the one or more processor cores, each energy consumption estimate for each sampling window for each processor unit to a controller of the processor;
determining, by the controller, one or more activity adjustment control signals, each of the one or more activity adjustment control signals operable to cause an adjustment of activity of a processor core; and
providing, by the controller, the one or more activity adjustment control signals to one or more corresponding processor cores to which they are addressed.

12. The method of claim 11, further comprising, prior to each processor unit monitoring for the occurrences of the events, sending, from the controller to each processor unit, a synchronizing pulse to each processor unit to initiate each sampling window of a plurality of sampling windows.

13. The method of claim 11, wherein a power consumption estimate for each processor unit for each sampling window is determined by dividing each energy consumption estimate by a duration of each sampling window.

14. The method of claim 11, wherein:
for each processor unit, each of the events that are monitored is associated with a respective weight determined for the event;
for each processor unit, determining energy consumption estimates for the plurality of sampling windows comprises, for each sampling window:
for each event of the set of events for each processor unit:
counting a number of occurrences of the event during the sampling window;
multiplying the number of occurrences of the event during the sampling window by the respective weight associated with the event to determine a product for the event;
for all the events, summing the product of the events to determine the energy consumption estimate by the processor unit during the sampling window.

15. The method of claim 14, wherein each respective weight is programmable by the controller.

16. The method of claim 12, further comprising transmitting, by one or more multiplexers, each multiplexer associated with a processor core, each energy consumption estimate and a sampling window duration for each of the plurality of sampling windows to the controller.

17. The method of claim 11, wherein the one or more activity adjustment control signals comprise at least one of a clock frequency adjustment signal, a voltage adjustment signal, a throttling adjustment signal, or a current adjustment signal.

18. The method of claim 11, wherein the one or more activity adjustment control signals are generated in response to a power parameter comprising at least one of a current, a power, a differential power, a differential current, and an energy.

19. The method of claim 11, wherein durations for each of the plurality of sampling windows are programmable by the controller.

20. A non-transitory computer readable medium storing instructions that, when executed by a processor that includes one or more processor cores, wherein each of the one or more processor core comprises a plurality of processor units, each processor unit is configured to perform a particular processor core function, and a controller, causes the processor to perform the operations of:
monitoring, for each processor unit of the plurality of processor units of the one or more processor cores, for occurrences of events in a set of events for the processor unit, each set of events specific to the processor unit;
determining, for each processor unit, for a plurality of sampling windows, wherein at least some of the sampling windows are different from each other sampling window, an energy consumption estimate for the sampling window based on the monitored occurrences of the events;
providing, for each of the one or more processor cores, each energy consumption estimate for each sampling window for each processor unit to the controller;
determining, by the controller, one or more activity adjustment control signals, each of the one or more activity adjustment control signals operable to cause an adjustment of activity of a processor core; and
providing, by the controller, the one or more activity adjustment control signals to one or more corresponding processor cores to which they are addressed.
